(19) United States
(12) Patent Application Publication
(10) Pub. No.: US 2009/0272233 A1
(43) Pub. Date: Nov. 5, 2009

(54) Tong Unit Having Multi-Jaw Assembly Gripping System

(76) Inventor: Clint Musemeche, Youngsville, LA (US)

Correspondence Address: LAW OFFICE OF JESSE D. LAMBERT, L.L.C., 406 AUDUBON BLVD., LAFAYETTE, LA, 70503, US

(21) Appl. No.: 12/433,468

(22) Filed: Apr. 30, 2009

Related U.S. Application Data
(60) Provisional application No. 61/049,472, filed on May 1, 2008.

(51) Int. Cl. E21B 19/16; B25B 13/50

(52) U.S. Cl. 81/57.16; 81/57.18

(57) ABSTRACT

A jaw assembly, namely a multi-jaw assembly (preferably three-jaw) for a tong unit. The jaw assembly has a rear jaw connected to two side jaws, by pivot pins, to form a multi-jaw jaw assembly. The pivot pins pass through the upper and lower cage plates on the tong unit; as such, the jaw assembly must move along with the cage plates. The rear jaw, with respect to the cage plates, is stationary. The side plates, by virtue of the pivot pins, are rotatably attached with respect to the cage plates. The rear jaw and side jaws carry dies, typically two dies on the rear jaw and one die on each of the side jaws, for gripping a tubular. The multi-jaw assembly permits efficient gripping of undersize and/or out-of-round tubulars, and application of torque thereto, without damage to the tubular.

### CROSS REFERENCE TO RELATED APPLICATIONS

This regular patent application claims priority to U.S. provisional patent application Ser. No. 61/049,472, filed May 1, 2008, for all purposes.

### BACKGROUND

1. Field of the Invention

This invention relates to apparatus used to screw together (or “make up”) and unscrew (or “break out”) threaded tubular connections joining sections (frequently called “joints”) of tubulars. Such tubulars are frequently used in the drilling, servicing and completion of oil and gas wells, in the form of drill pipe, tubing, and other similar tubular goods. Such apparatus are commonly referred to as “tong units” or “power tongs,” which use toothed dies carried by tong jaws, to transmit torque to the tubular connection. It is to be understood that the term tong unit, for purposes of this application, encompasses both the portion commonly referred to as the power tong portion of the tong unit (that is, the part that turns one side of the tubular connection) and the portion commonly referred to as the backup portion of the tong unit (that is, the part which holds the other side of the tubular connection).

In more detail, this invention relates to a tong unit which comprises a multi-part or multi-jaw, preferably three part, jaw system, as more particularly described herein.

2. Related Art

By way of background, an exemplary tong unit will be described in sufficient detail to enable those having ordinary skill in the relevant art field to understand how the present invention is incorporated therein.

### Tong Unit Jaw Systems Generally

With reference to FIG. 1, a tong unit 10 comprises a main body 11 which carries a gear system, generally referred to as 20, driven by a motive source, typically a hydraulic motor 30. As is well known in the art, rotation of the motor turns the gears, which turn ring gear 40. Ring gear 40 is disposed within a central opening of main body 11, as can be seen in FIG. 1. The rotary movement of ring gear 40, and thereby torque, is transmitted from ring gear 40 to a jaw assembly referred to in globo as 50, thence to dies 60 carried in the jaw assembly, and ultimately to a tubular connection 70 (shown in cross section), by the dies pressing against and/or biting into the metal of the connection. As is known in the art, the jaws are held within the ring gear by cage plates both above and below the ring gear, not shown in FIG. 1 for clarity, but which are shown in FIGS. 3-5 and explained below.

Ring gear 40 comprises a central opening which comprises cam surfaces 41. As can be readily seen in FIG. 1, and as is known in the art, rotation of ring gear 40 relative to rollers 80 brings cam surfaces 41 to bear against rollers 80 (which are carried by the different jaws of the jaw assembly, described in more detail below), camming the rollers and jaw assemblies inwardly toward one another and toward the tubular connection. The dies then bite into the tubular connection; further inward motion is therefore stopped, and the jaws and ring gear are then rotationally locked, thereby permitting very high torque to be transmitted to the tubular connection.

### Prior Art, Two-Jaw Systems

Prior art tong units used a jaw assembly comprising two jaws, with two dies per jaw, as seen in FIGS. 2A and 2B. A limitation of this configuration arises when undersize and/or out-of-round tubulars are to be gripped by the jaw system. On undersize tubulars, as the two jaws 200 and 400 are forced inwardly toward the tubular (typically, as described above, by cam surfaces in the ring gear acting on rollers carried by the jaws) and thereby rotated about their respective hinge points, only one of the two dies on a given jaw may contact the tubular. As can be readily appreciated, in such situation the gripping ability is very much reduced, and the single-die contact can result in undesirable radial forces being applied.

### BRIEF DESCRIPTION OF THE DRAWINGS

FIG. 1 is a top view of the power tong portion of a tong unit, in partial cross-section, showing the three jaw gripping system of this invention.

FIGS. 2A and 2B are top views of a prior art, two-jaw assembly gripping system.

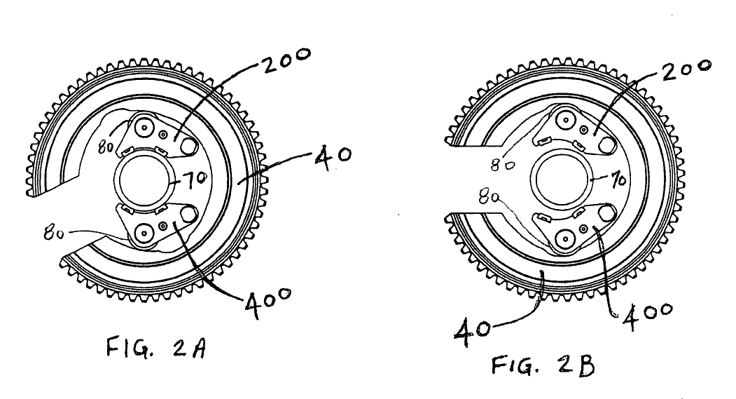

FIG. 3 is a perspective view of parts of a tong unit comprising the present invention.

FIG. 4 is a perspective view of certain parts of a tong unit comprising the present invention.

FIG. 5 is a side view of the tong unit parts shown in FIG. 4.

FIG. 6 is a top view of the multi-jaw (three jaw) jaw assembly of the present invention.

FIG. 7 is a perspective view of the multi-jaw assembly.

FIG. 8 is a top view of the multi-jaw assembly gripping system, as typically configured in the backup portion of a tong unit.

### DETAILED DESCRIPTION OF THE PRESENTLY PREFERRED EMBODIMENT(S)

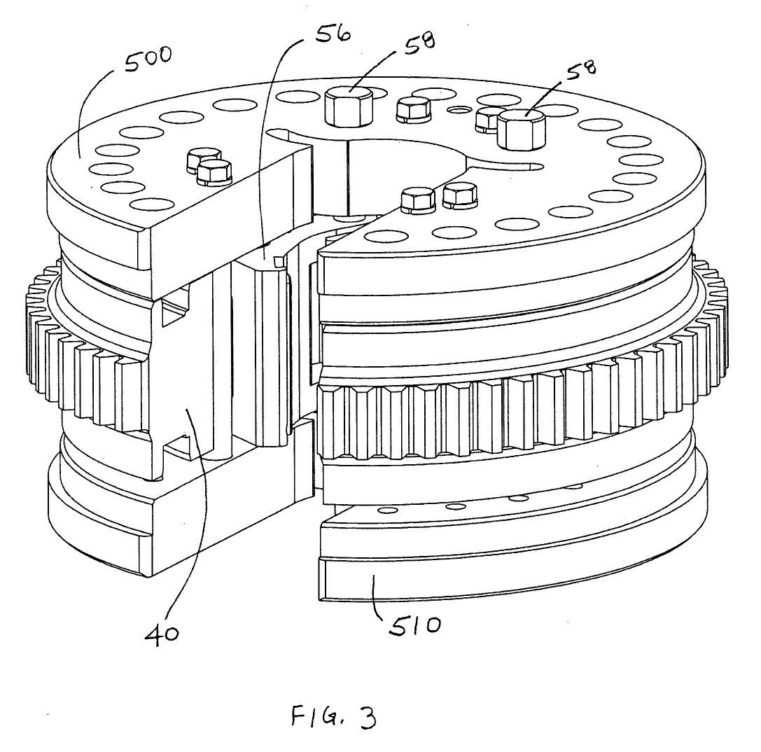

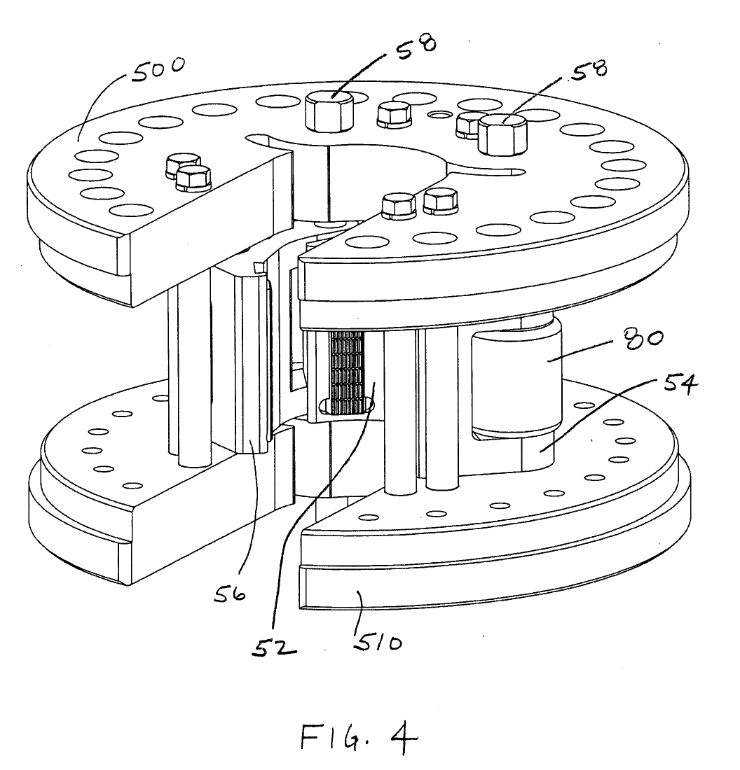

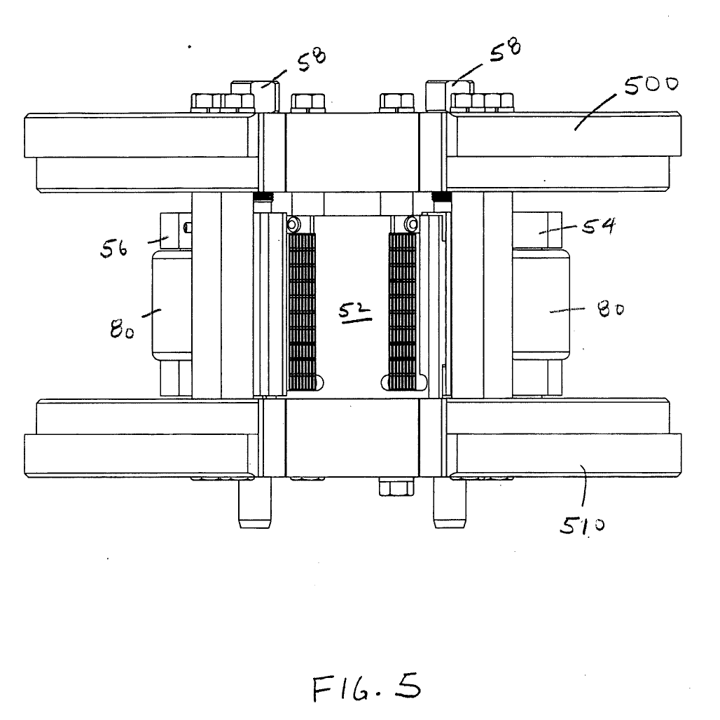

FIGS. 3-5 first show the jaw assembly or gripping system of the present invention in combination with certain other elements of a tong unit, in order to better explain the gripping system's placement in the tong unit. FIG. 3 is a perspective view of several components removed from the main body of the tong unit, namely ring gear 40, top and bottom cage plates 500 and 510, and the multi-jaw assembly of the gripping system, with one side jaw 56 visible (described in more detail later). FIG. 4 is a perspective view as in FIG. 3, but with ring gear 40 removed, so as to better show the multi-jaw jaw assembly 55. Side jaws 54 and 56, and rear jaw 52, can be seen, along with roller 80 mounted to side jaw 54 (the similar roller mounted to side jaw 56 not visible). FIG. 5 is a side view, looking down the open throat of the tong. Top and bottom cage plates 500 and 510; side jaws 54 and 56; rear jaw 52; and rollers 80 can all be seen. In FIGS. 3-5, pivot pins 58 (upon which side jaws 54 and 56 pivot, as described below) are also shown.

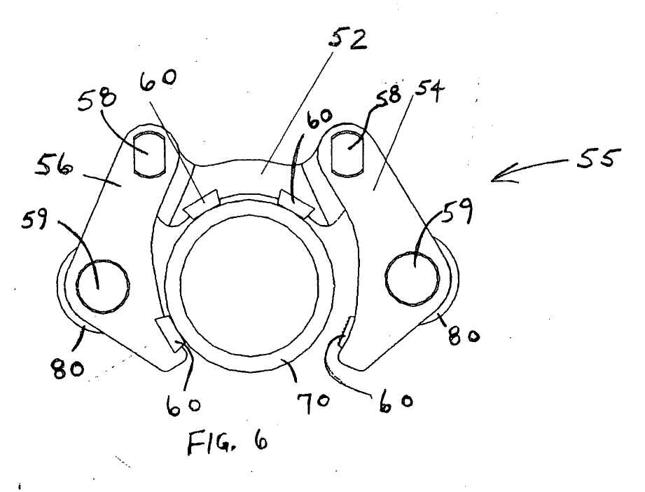

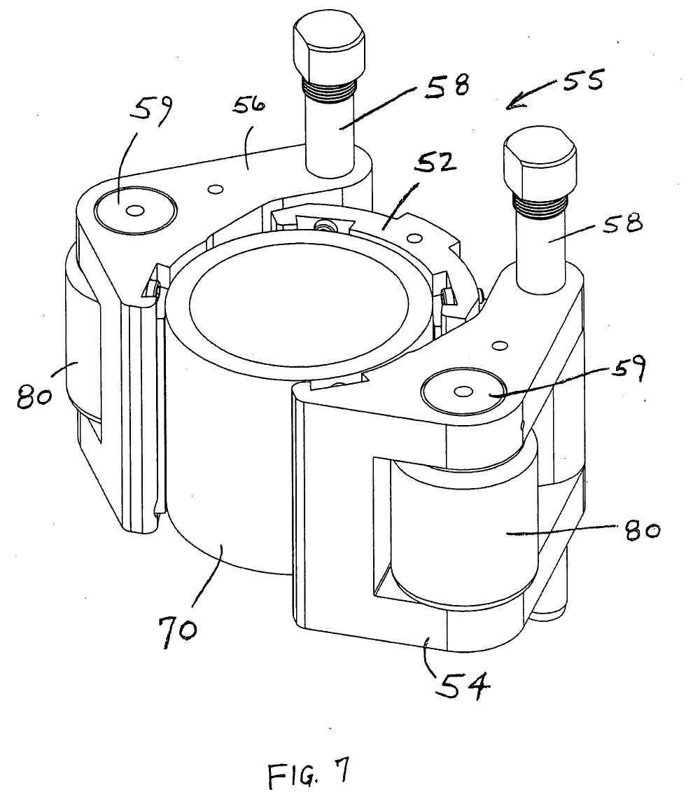

With further reference to the drawings, especially FIGS. 6 and 7: the multi-jaw jaw assembly 55 of the present invention comprises a rear jaw 52 and two side jaws 54 and 56. Rear jaw 52, with respect to cage plates 500 and 510, does not rotate; that is, while rear jaw 52 must move with top and bottom cage plates 500 and 510, rear jaw 52 does not pivot or rotate with respect to the cage plates. On the other hand, side jaws 54 and 56 (by virtue of their connection to cage plates 500 and 510 by pivot pins 58) are rotatably connected to cage plates 500 and 510 (that is, can swing inwardly and outwardly toward and away from a tubular in the ring gear opening).

Side jaws 54 and 56 are linked to rear jaw 52 by pivot pins 58. Side jaws 54 and 56 are free to pivot around pivot pins 58. Both side jaws preferably have rollers 80, held in the side jaws by roller pins 59. It is understood that pivot pins 58 pass through holes in the upper and lower cage plates (as can be seen in FIGS. 3-5), thereby connecting the jaw assembly to the cage plates and holding the jaws in place within the ring gear.

In a presently preferred embodiment, all three jaw segments carry dies 60, which, as described earlier, contact and bite into the tubular to provide gripping force. Rear jaw 52 preferably has two dies, while each of the side jaws 54 and 56 preferably carry only a single die. However, it is to be understood that other embodiments of the present invention may use different numbers of dies in each jaw, or in fact no dies at all, for example teeth incorporated into the jaws themselves, the use of abrasives or grit areas, etc.

The operation of the multi-jaw (namely, three-jaw) assembly gripping system can now be described with reference to the drawings, and the earlier description above regarding prior art, two-jaw systems. In a typical tong unit arrangement, brake bands on one or both of cage plates 500 and 510 tend to restrain rotation of the cage plates, and consequently of the multi-jaw assembly (which, as described earlier, is attached thereto by pivot pins 58). Therefore, as ring gear 40 rotates, relative rotation is created between cage plates 500 and 510, and the attached multi-jaw assembly, on the one hand; and ring gear 40, on the other hand. As a result, cam surface 41 moves relative to and contacts rollers 80, forcing the rollers, and consequently side jaws 54 and 56 inward, the side jaws rotating pivoting around pivot pins 58, and thereby rotating with respect to cage plates 500 and 510. Tubular connection 70 is forced into contact with the two dies on rear jaw 52. The single dies on side jaws 54 and 56 are forced against tubular connection 70, thereby completing the contact with the tubular connection. As described above, further rotation of ring gear 40 then necessarily results in rotation of tubular connection 70.

A benefit of the present invention is the increased ability to effectively grip undersize and/or out-of-round tubulars, by virtue of the stationary (with respect to the cage plate) rear jaw, into which is moved the tubular by the rotating (with respect to the cage plate) side jaws.

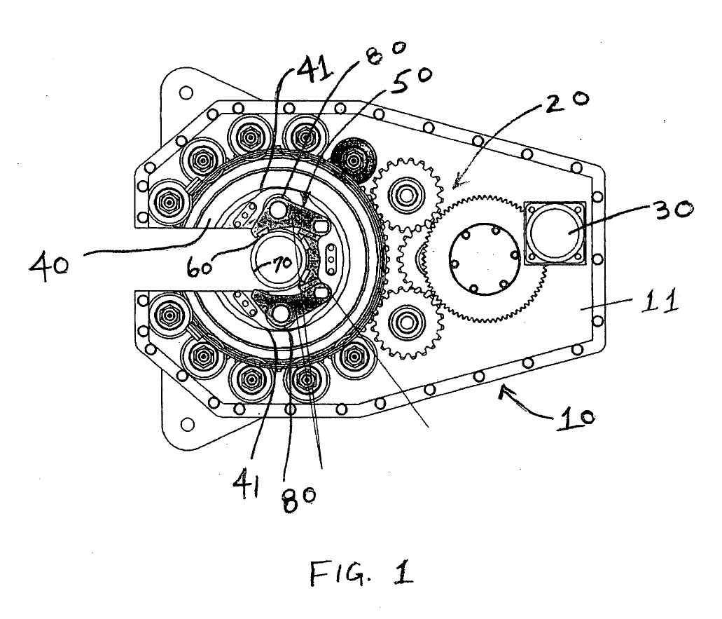

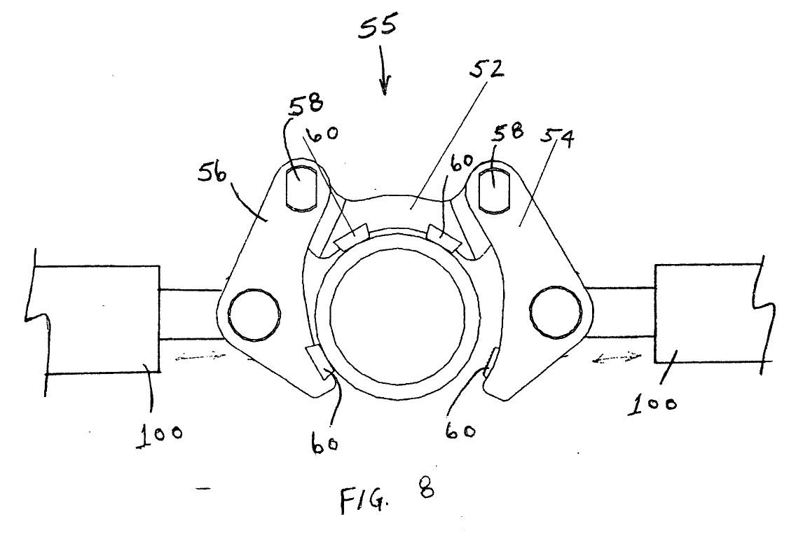

A similar system is used for the backup portion of a tong unit. The backup portion of a tong unit comprises a main tong body, generally as shown in FIG. 1, however the backup portion of a tong unit does not have the ring gear and cage plate arrangement previously described in connection with the power tong (makeup) portion of a tong unit, and further the side jaws do not have rollers for contact with cam surfaces on the inside surface of the ring gear. As shown in FIG. 8, typically, for the backup portion, jaw assembly 55 is connected to the tong body by pivot pins 58. Rear jaw 52 is stationary with respect to the tong body. Side jaws 54 and 56, by virtue of the pivot pins 58, are rotatably connected with respect to the tong body, and are pivoted toward tubular connection 70 by a means for rotating the side jaws with respect to the tong body. In a presently preferred embodiment, the means for rotating side jaws 54 and 56 comprises hydraulic cylinders 100 connected thereto, as shown in FIG. 8, in lieu of the ring gear/roller combination described above.

The geometry of the multi-jaw assembly gripping system of the present invention permits contact of all four dies on a tubular connection, even if the tubular connection diameter is undersize, or if the tubular connection is out-of-round.

### Materials

As is well known in the relevant art, the various components of this invention, as with other tong components, may be advantageously made from various metals which yield sufficient strength to handle the high loads imposed on them by the tong.

### Conclusion

While the preceding description contains many specificities, it is to be understood that same are presented only to describe some of the presently preferred embodiments of the invention, and not by way of limitation. Changes can be made to various aspects of the invention, without departing from the scope thereof. For example, different materials may be used for different parts of the invention; dimensions may be changed to accommodate various sizes of tubular goods and to suit different applications; the side jaws may number greater than two; the rear jaw may comprise more than two dies, etc.

Therefore, the scope of the invention is to be determined not by the illustrative examples set forth above, but by the appended claims and their legal equivalents.

I claim:

1. A tong unit, comprising:
a ring gear having a central opening;
a cage plate disposed above said ring gear, and a cage plate disposed below said ring gear;
a jaw assembly disposed within said central opening of said ring gear, and connected to said cage plates, said jaw assembly comprising:
a rear jaw which is stationary with respect to said cage plates; and
at least two side jaws, one of said side jaws on each side of said rear jaw, each of said side jaws being rotatably connected with respect to said cage plates.

2. The tong unit of claim 1, wherein:
said ring gear comprises a cam surface within said central opening;
said side jaws comprise rollers;
and wherein with relative rotation between said cage plates and said ring gear said cam surface acts on said rollers and rotates said side jaws into contact with a tubular.

3. The tong unit of claim 2, wherein said rear jaw and said side jaws further comprise dies.

4. The tong unit of claim 3, wherein said rear jaw comprises two dies, and each of said side jaws comprise one die.

5. A tong unit, comprising:
a main body having a central opening;
a jaw assembly disposed within said central opening of said main body, said jaw assembly comprising:
a rear jaw which is stationary with respect to said main body; and
at least two side jaws, one of said side jaws on each side of said rear jaw, each of said side jaws being rotatably connected with respect to said main body.

6. The power tong of claim 5, further comprising a means for rotating said side jaws with respect to said main body.

7. The power tong of claim 6, wherein said means for rotating said side jaws comprises hydraulic cylinders attached to said side jaws.

8. The tong unit of claim 7, wherein said rear jaw and said side jaws further comprise dies.

9. The tong unit of claim 8, wherein said rear jaw comprises two dies, and each of said side jaws comprise one die.
